(19) United States
(12) Patent Application Publication
(10) Pub. No.: US 2011/0291429 A1
(43) Pub. Date: Dec. 1, 2011

(54) Process for Coating Metal Components With a Coating That Prevents Electrochemical Plating

(75) Inventors: James L. Anderson, JR., Howell, MI (US); Gregory J. Zang, Canton, MI (US); Mark J. Brey, Flat Rock, MI (US); Michael B. Maloney, Clinton, MI (US); Richard R. Steiner, Findlay, OH (US); Bruce A. Newboles, Flat Rock, MI (US)

(73) Assignee: Flat Rock Metal Inc., Flat Rock, MI (US)

(21) Appl. No.: 13/115,528

(22) Filed: May 25, 2011

Related U.S. Application Data
(60) Provisional application No. 61/349,566, filed on May 28, 2010.

(51) Int. Cl. B60R 19/03; B05D 3/00; B05D 3/12; B05D 7/14; B05D 5/00; B05D 5/06; B05D 1/18; B05D 1/28; B05D 1/04; B05D 3/02; B05D 3/06; B05D 1/36; B05D 1/02

(52) U.S. Cl. 293/102; 427/327; 427/292; 427/458; 427/557; 427/180

(57) ABSTRACT

The present invention is directed to a method of coating metal articles with a flexible, chemical-resistant, corrosion-resistant, and abrasion-resistant coating that can be optionally formed and optionally electroplated. In some examples, the articles are metal motor vehicle bumpers.

### RELATED APPLICATION

This Application claims the benefit of U.S. Provisional Application 61/349,566 filed on May 28, 2010, which is entirely incorporated herein by reference.

### FIELD OF THE INVENTION

The present invention is directed to a method of coating metal articles with a flexible, chemical-, corrosion-, and abrasion-resistant coating that can be optionally formed and optionally electroplated. In some examples, the articles are metal motor vehicle bumpers.

### BACKGROUND OF THE INVENTION

In the manufacturing of a plated article, the traditional technique is to form a flat metal sheet into the desired shape, and then clean, plate, and paint the surface. For example, in traditional manufacturing of a metal motor vehicle bumper (e.g., a chrome bumper for automobiles and trucks), a sheet of untreated metal is formed into the desired bumper shape using multistep metal stamping and pressing processes to create a three dimensional article that has bends and curves. The formed metal is then polished and electrochemically cleaned by passing it through acidic and alkaline chemical baths to remove any dirt, oils, lubricants, drawing fluids, and processing residue. The front surface, which is the outer side of the finished and installed bumper, is electroplated with one or more layers of metal, for example nickel and chromium. The back surface, which is the inner side of the finished and installed bumper, is plated as well when the formed bumper is immersed in metal baths during the plating process. After plating, a back side coating is applied to cover the residual metal on the back surface. Typically, this back side coating is a dark, fast-curing paint or wax that is applied by spraying by hand on the formed article, which results in overspray on the front plated surface. This is then removed from the electroplated front surface by hand before the bumper is installed.

A coating that is anti-corrosive is necessary for metal articles, such as the back side of electroplated metal bumpers, because corrosion and rust can result in unsightly dripping or staining onto the trim elements of the motor vehicle. Corrosion also weakens the structural integrity of the bumper. While electrochemical plating provides corrosion resistance, plating the back side potentially increases production costs, because it deposits expensive metallic layers on a surface that it not exposed to view.

Thus, a need remains for a method of coating a metal article with a chemical-, corrosion-, and abrasion-resistant coating that is flexible enough to withstand optional formation into a desired shape and optional electroplating with one or more additional coatings.

### SUMMARY OF THE INVENTION

These and other needs are met by the present invention, which is directed to a method of coating the surface of a metal article. The coating comprises a novel method of painting the back side of a flat metal sheet, before forming, with a coating that is chemical-, corrosion-, and abrasion-resistant. In addition, the coating is flexible enough to withstand optional forming with multistep metal pressing and stamping processes. The coating also resists electroplating, when an uncoated surface of the metal article is to be optionally electroplated. The coating is comprised of a pretreating compound, a sealer, a primer, and a top coat. This coating method reduces the overall cost of manufacturing a metallic plated article by reducing the consumption or expensive metals on the back side and eliminating several coating steps that require manual application and removal. The method can be used in the manufacturing of formed metal articles, such as a metal motor vehicle bumper.

The coating of the present invention also adds and enhances corrosion-resistance, which is particularly desirable in metal motor vehicle bumpers, as corrosion can cause unsightly dripping or staining onto the trim elements of the motor vehicle and degradation of the structural integrity of the bumper. Corrosion resistance is also desirable in other metal articles, for example, motor vehicle mirrors and other trim elements.

In the manufacturing of metal motor vehicle bumpers, the flat metal sheet will ultimately be formed into a three dimensional metal bumper. Once formed, the front side is the outer side of the finished and installed bumper, which will be the target for electrochemical plating with one or more metallic layers. The back side of the motor vehicle bumper is the inner side of the finished and installed bumper, which will be the target for coating according to the present invention.

The coating of the present invention also provides abrasion-resistance, which is particularly important in the forming process of metal articles. For example, in forming a metal bumper, the metal sheet is subjected to multistep stamping and pressing processes that can deliver several tons of force. The coating of the present invention is not compromised during this stamping process, and it maintains complete adhesion to the metal. Thus, the coating is abrasion-resistant, and it will not be scraped off during the forming process.

The method of the present invention is possible through a variety of combinations or surface preparations and coating layers that result in a coated metal article. Common to each series of coating layers is a general method that encompasses the various steps of the present invention. Thus, in one aspect, the invention relates to a method of coating the surface of a metal article, comprising the steps of:
a. cleaning the metal surface with one or more alkaline cleaners;
b. pretreating the metal surface with one or more phosphate-containing pretreating compounds;
c. applying one or more corrosion-resistant sealers to the metal surface;
d. applying one or more corrosion-resistant primers to the metal surface; and
e. applying one or more chemical- and corrosion-resistant top coats to the metal surface,

wherein the resulting metal surface is chemical-, corrosion-, and abrasion-resistant.

In a further aspect, the invention relates to a method of coating the surface of a metal article, comprising the steps of:
a. cleaning the metal surface with Betz Kleen 132® or 111 Low Foam Cleaner®;
b. pretreating the metal surface with one or more pretreating compounds selected from the group consisting of Permatreat® 1510, Permatreat® 2105, Bonderite 902, Bonderite 2010, ChemCote 3010, Gardobond 51/2, and Permatreat® 407;
c. applying Bonderite 1455 SF to the metal surface;
d. applying a polyester resin primer system that contains hydroxyl groups that are crosslinked with blocked or unblocked isocyanates; and
e. applying a PVC plastisol top coat coating,

wherein the resulting metal surface is chemical-, corrosion-, and abrasion-resistant.

In a further aspect, the invention relates to a metal motor vehicle bumper, wherein the metal bumper characterized by a surface that is:
a. cleaned with Betz Kleen 132® or 111 Low Foam Cleaner®;
b. pretreated with one or more pretreating compounds selected from the group consisting of Permatreat® 1510, Permatreat® 2105, Bonderite 902, Bonderite 2010, ChemCote 3010, Gardobond 51/2, and Permatreat® 407;
c. sealed with Bonderite 1455 SF;
d. coated with a polyester resin primer system that contains hydroxyl groups that are crosslinked with blocked or unblocked isocyanates; and
e. coated with a PVC plastisol top coat;
wherein the resulting metal motor vehicle bumper has a chemical-, corrosion-, and abrasion-resistant coating.

### BRIEF DESCRIPTION OF THE FIGURES

FIG. 1 is a production flowchart that illustrates a manufacturing process for making a metal motor vehicle bumper.

### DETAILED DESCRIPTION OF THE INVENTION

### Embodiments

As indicated, one aspect of the invention is directed to a method of coating the surface of a metal article. First, the metal is cleaned with one or more alkaline cleaners. Next, the metal is pretreated with one or more phospate-containing pretreating compounds. Then, one or more corrosion-resistant sealers are applied to the metal surface, followed by one or more corrosion-resistant primers. Finally, a chemical- and corrosion-resistant top coat is applied to the metal surface.

### Type of Metal Articles

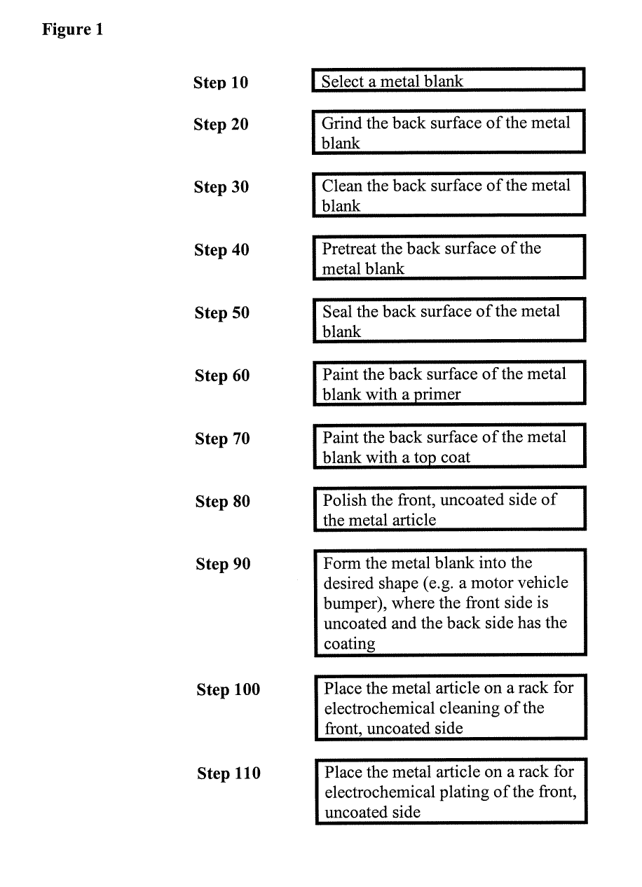

Choosing a metal is depicted as Step 10 of FIG. 1. The coating of the invention can be applied to the surfaces of a wide variety of metals. Thus, in one embodiment, the coating can be applied to a pre-formed metal article. In another embodiment, the metal is a metal blank. In another embodiment, the metal is a metal blank that has a thickness between 0.001 and 5 inches. More particularly, the metal is a metal blank that has a thickness between 0.005 and 1 inch. In another embodiment, the metal blank has a thickness between 0.001 and 0.250 inch. More particularly, the metal blank has a thickness between 0.020 and 0.150 inch.

In another embodiment, the metal blank can eventually be subject to post-coating formation.

The metal chosen will depend on the end use of the metal article. In one embodiment, the metal is a metal blank that will ultimately be formed and plated for use as a motor vehicle bumper or bumper accessory.

In one embodiment, the metal article is selected from the group consisting of brushed or unbrushed hot rolled steel, brushed or unbrushed cold rolled steel, and brushed or unbrushed high strength steel, or the like. More particularly, the metal is cold rolled steel. Alternatively, the metal is selected from the group consisting of Drawing Steel (ASTM Specifications A1008 and A1011), Deep Drawing Steel (ASTM Specification A1008), Extra Deep Drawing Steel (ASTM Specification 1008), and High Strength Low Alloy Steel (ASTM Specifications A606 and A1008), or the like.

In one embodiment, the metal surface is pickled via techniques readily available in the art, including, but not limited to, treatment with a pickling liquor containing a strong acid, such as a mineral acid selected from the group consisting of sulfuric acid, hydrochloric acid, and mixtures thereof, or the like. In another embodiment, the metal surface is nonpickled.

### Grinding the Surface of the Metal Article

In one embodiment, the surface of the metal article to be coated may be slightly ground, using methods known in the art, to remove any production residue and oil or grease coating that may have been applied to prevent or minimize corrosion during shipment and storage. The mechanical grinding process may be dry or wet using water. This mechanical grinding process will also provide an abraded surface that will increase the adherence of the coating layers. The material used to grind can be, for example, but not limited to, sandpaper, synthetic woven mesh, brushes, and combinations thereof, or the like. Grinding the surface of the metal is depicted as Step 20 in FIG. 1.

### Cleaning the Surface of the Metal Article

The surface of the metal article to be coated is then cleaned to remove any residue that is present on the surface. This is shown as Step 30 in FIG. 1. A variety of cleaners may be used. In one embodiment, the cleaner is an alkaline cleaner. More particularly, the cleaner is selected from the group consisting of Betz Kleen 132®, 111 Low Foam Cleaner® (available from Torch Surface Technologies), and mixtures thereof, or the like.

In one embodiment, the cleaning step is accomplished by any cleaning method known in the art, for example, but not limited to, in a vat, by surface spraying or scrubbing, and combinations thereof, or the like. More particularly, the surface of the metal article is cleaned by surface spraying and scrubbing. After the cleaning step is complete, the metal article must be completely dried by any drying method known in the art, for example, but not limited to, air drying.

### Pretreating the Surface of the Metal Article

After cleaning, the surface of the metal article to be coated is pretreated using a phosphate-containing pretreating compound to improve paint adhesion and minimize the risk of corrosion. This is depicted as Step 40 in FIG. 1. Examples of pretreatment compounds include, but are not limited to, chromic phosphate, ferrous phospate, ferric phosphate, zinc phosphate, and mixtures thereof, or the like. More particularly, the pretreating compound is selected from the group consisting of Permatreat® 1510 (available from Betz Laboratories, Inc.), Permatreat® 2105 (available from Betz Laboratories, Inc.), Bonderite 902 (available from Henkel Corporation), Bonderite 2010 (available from Henkel Corporation), ChemCote 3010 (available from Chemetall and Oakite), Gardobond 51/2 (available from Chemetall and Oakite), Permatreat® 407 (available from Betz Laboratories, Inc.), and mixtures thereof, or the like.

The metal article should be completely dry before the pretreatment compound is applied. The pretreatment compound can be applied by any method known in the art, including, but not limited to, spraying, dipping, brush coating, roll coating, and combinations thereof, or the like. In one embodiment, the coating weight will generally be between 10-100 mg/ft². More particularly, the pretreatment layer has a coating weight of 20-45 mg/ft².

More than one pretreatment compound can be applied to the metal surface if necessary based on the end use of the metal article. Different pretreatment compounds may be used depending on the type of metal, the end use of the metal article, and the other layers of the coating.

### Sealing the Surface of the Metal Article

An anti-corrosion sealer is then applied to the surface of the metal article, as shown by Step 50 in FIG. 1. The sealer can also improve paint adhesion to the metal. Appropriate sealers are generally chrome or non-chrome. In one embodiment, a chrome sealer is applied. Examples of chrome sealers include, but are not limited to, Betz Sealguard™ (available from Betz Laboratories, Inc.), Bonderite 1402W (available from Henkel Corporation), Gardobond C 4571 (available from Chemetall), and mixtures thereof, or the like. In another embodiment, a non-chrome sealer is applied. Examples of non-chrome sealers include, but are not limited to, Betz® DC2068 (available from Betz Laboratories, Inc.), Bonderite 1455 SF (available from Henkel Corporation), and mixtures thereof, or the like. More particularly, in one embodiment, the sealer is Bonderite 1455 SF.

The sealer may be applied by any method known in the art, including, but not limited to, spraying, dipping, brush coating, roll coating, and combinations thereof, or the like. In one embodiment, more than one sealer can be applied to surface of the metal article if necessary based on the end use of the metal article. In one embodiment, the sealer has a coating weight of 2-50 mg/ft². More particularly, in one embodiment, the sealer has a coating weight of 4-16 mg/ft².

Different sealers will be used depending on the type of metal, end use of the metal article, and the additional components used in the coating. In one embodiment, more than one sealer is applied to the metal surface. The sealer may be allowed to dry completely after application.

### Priming the Surface of the Metal Article

The surface of the metal article is then primed with a primer having flexibility, chemical-resistance, corrosion-resistance, and abrasion-resistance. This step is depicted as Step 60 in FIG. 1. The chosen primer will depend on the end use of the metal article. Suitable primers include, but are not limited to, water borne primers, solvent borne primers, liquid solvent borne high solids primers, powder coating primers, and mixtures thereof, or the like. More particularly, in one embodiment, the primer is based on a material selected from the group consisting of thermoplastic acrylic, polyester, polyvinyl, polyepoxy, polyurethane, polyamide, polyamine, acrylic carbamate resin systems, and mixtures thereof, or the like. In another embodiment, the primer is selected from the group consisting of UV and Electron Beam cured coatings, or the like.

In one embodiment, the primer is a thermosetting composition with a curable resin that has functional groups. More particularly, those functional groups that are selected from the group consisting of hydroxyl, carboxylic acid, carbamate, anhydride, amine, epoxy, amide, carbonate, and mixtures thereof, or the like. In one embodiment, the functional groups of the curable resin are reacted with a crosslinking agent to form a crosslinked network. More particularly, the crosslinking agent is selected from the group consisting of isocyanates, blocked isocyanates, aminoplasts, melamines, epoxies, anhydrides, and mixtures thereof, or the like. More particularly, in one embodiment, the primer is a polyester resin system that contains hydroxyl groups that are crosslinked with blocked or unblocked isocyanates.

In another embodiment, the viscosity of a solvent borne primer is adjusted with a standard organic solvent. More particularly, the viscosity of a solvent borne primer is adjusted with a standard organic solvent selected from the group consisting of ketones, acetates, non polar aliphatic hydrocarbons, polar aliphatic hydrocarbons, polar aromatic solvents, non-polar aromatic solvents, alkyl polyethers, alkyl polyether acetates, and mixtures thereof, or the like. The final viscosity of the primer is measured using a Zahn #2 viscosity cup at a temperature of 70° F. The viscosity of the primer is 20-40 seconds. More particularly, the viscosity of the primer is 28-32 seconds.

The primer can be pigmented with one or more pigments to achieve a desired color and improve corrosion resistance. The primer may contain chrome or non-chrome pigments. In one embodiment, the pigment is non-chrome. More particularly, the pigment is chosen from the group consisting of organic or inorganic compounds or colored materials, fillers, metallic or other inorganic flake materials, and mixtures thereof, or the like. Examples of pigments include, but are not limited to, carbon black pigment, titanium dioxide, iron oxide, chrome yellow, moly orange, titanium yellow, nickel titanate yellow, chrome green, phathalo blue, phathalo green, perylene red, magenta red, and mixtures thereof, or the like. In one embodiment, more than one pigment is applied to the metal surface.

The primer is applied using a method known in the art, including, but not limited to, air atomized spray, air assisted airless spray, airless spray, HVLP spray, electrostatic rotary bell spray, electrostatic air atomized spray, electrostatic air assisted airless spray, electrostatic HVLP spray, direct roll coating, reverse roll coating, flow coating, dipping, curtain coating, and combinations thereof, or the like. The dry film thickness of the primer should be about 2.5 to 50 microns. More particularly, the primer has a dry film thickness of 10 microns to 20 microns.

The primer is completely cured after application using methods known in the art, including, but not limited to, heating and UV light. In one embodiment, the primer is cured by a method selected from the group consisting of a heating means, short or medium long wave infrared light, and a combination of a heating means and infrared light. In one embodiment, the primer is cured using a heating means with ovens that reach a peak metal temperature of 370-450° F., with an oven dwell time of 30-300 seconds. More particularly, the primer is cured using a heating means with ovens that reach a peak metal temperature of 400-420° F., with an oven dwell time of 60-180 seconds. In one embodiment, the heating means is an electric or natural gas convection oven.

A completely cured primer gives 5-75 methyl ethyl ketone double rubs, according to ASTM Test Method D5402-06. More particularly, the cured primer gives 5-50 methyl ethyl ketone double rubs, according to ASTM Test Method D5402-06.

### Applying a Top Coat to the Surface of the Metal Article

A top coat is then applied to the surface of the metal article, as shown by Step 70 in FIG. 1. The chosen top coat must adhere to the primer layer below it, be flexible, chemical-resistant, and corrosion-resistant. The chosen top coat will depend on the end use of the metal article. In one embodiment, the top coat is selected from the group consisting of thermoplastic or thermoset water borne, solvent borne, solvent borne high solid, powder coating based on acrylic, polyester, epoxy, urethane, polyamide, polyamine, carbamate, polyvinylidine fluoride resin systems, and mixtures thereof, or the like. In one embodiment, thermoset top coats are crosslinked with isocyanates, blocked isocyanates, melamines, epoxies, and mixtures thereof, or the like. More particularly, in another embodiment, the top coat is selected from the group consisting of colloidal dispersions of polyvinyl chloride, formulated with the appropriate plasticizers that will give the desired film properties. More particularly, the plasticizers are phthalate or non-phthalate based materials.

In another embodiment, the top coat is selected from the group consisting of UV and Electron Beam cured coating, or the like.

A non-limiting example of a suitable top coat is a PVC plastisol coating, which is prepared by emulsion or microemulsion polymerization in plasticizers and solvents. Upon heating or curing, the plasticizers diffuse into the dispersed polymer particles, inducing plasticization of the coating. The resulting coating is highly elastic, abrasion resistant, chemical-resistant, and dimensionally stable.

In another embodiment, the viscosity of a solvent borne top coat is adjusted with a standard organic solvent. More particularly, the viscosity of a solvent borne top coat is adjusted with nonpolar mineral spirits or a standard organic solvent selected from the group consisting of ketones, acetates, non polar aliphatic hydrocarbons, polar aliphatic hydrocarbons, polar aromatic solvents, non-polar aromatic solvents, alkyl polyethers, alkyl polyether acetates, and mixtures thereof, or the like. In one embodiment, the viscosity can be adjusted with a solvent selected from the group consisting of Aromatic 100, 150, and 200 (available from Exxon Mobil), and mixtures thereof, or the like. The final viscosity of the topcoat is measured using a Zahn #4 viscosity cup at a temperature of 70° F. The viscosity of the reduced topcoat is 15-40 seconds. More particularly, the viscosity of the reduced topcoat is 22-27 seconds.

The chosen top coat can be pigmented with one or more pigments to achieve a desired color. In one embodiment, the colored pigment is inorganic. More particularly, the colored pigment is an inorganic pigment selected from the group consisting of zinc white, zinc sulfide, carbon black, iron manganese black, spinel black, chromium oxide, chromium oxide hydrate green, cobalt green, ultramarine green, cobalt blue, ultramarine blue, manganese blue, ultramarine violet, cobalt violet, manganese violet, red iron oxide, molybdate red, ultramarine red, brown iron oxide, mixed brown iron oxide, yellow iron oxide, nickel titanium yellow, chromium titanium yellow, cadmium sulfide, cadmium zinc sulfide, chromium yellow, bismuth vanadate, and mixtures thereof, or the like.

In another embodiment, the colored pigment is organic. More particularly, the colored pigment is an organic pigment selected from the group consisting of monoazo pigments, diazo pigments, anthraquinone pigments, bexnzimidazole pigments, quinacridone pigments, quinophthalone pigments, diteopyrrolopyrrole pigments, dioxzine pigments, indanthrone pigments, isoindolien pigments, isoindolinone pigments, azomethine pigments, perinone pigments, perylene pigments, phthalocyanine pigments, aniline black, and mixtures thereof, or the like.

The top coat is applied using a method known in the art, including, but not limited to, air atomized spray, air assisted airless spray, airless spray, HVLP spray, electrostatic rotary bell spray, electrostatic air atomized spray, electrostatic air assisted airless spray, electrostatic HVLP spray, direct roll coating, reverse roll coating, flow coating, dipping, curtain coating, and combinations thereof, or the like. The top coat should have a dry film thickness of 2.5-400 microns. More particularly, the dry film thickness of the top coat should be about 20 to 150 microns. In one embodiment, more than one top coat is applied to the metal surface.

The top coat is completely cured after application using methods known in the art, including, but not limited to, heating and UV light. In one embodiment, the top coat is cured by a method selected from the group consisting of a heating means, short or medium long wave infrared light, and a combination of a heating means and infrared light. In one embodiment, the primer is cured using a heating means with ovens that reach a peak metal temperature of 370-450° F., with an oven dwell time of 30-300 seconds. More particularly, the primer is cured using a heating means with ovens that reach a peak metal temperature of 400-420° F., with an oven dwell time of 60-180 seconds. In one embodiment, the heating means is an electric or natural gas convection oven.

### Forming and Plating the Metal Article

Once the surface of the metal article has been coated, it can be handled, stacked, stored, or shipped. In one embodiment, the coated metal article is one side of a metal blank. In one embodiment, the uncoated front side of the metal article can be flat polished to the desired surface finish, as shown by Step 80 in FIG. 1, followed by being formed into its desired three-dimensional shape, as shown by Step 90 in FIG. 1. For some articles, the coated side will become the back side of the article, and additional processing, including, but not limited to, plating with one or more metals, will be performed on the front side. Articles may be formed by processes known in the art, including, but not limited to, stamping, bending, or using forming dies.

A non-limiting example of an article that can be formed is a motor vehicle bumper. The uncoated front side of the metal article can be polished to provide a smooth, unblemished metal surface, as shown by Step 80 in FIG. 1. Before plating, the uncoated surface of the bumper can be cleaned by immersion soaking, cathodic cleaning, and anodic cleaning, using methods well known in the art. In each of the cleaning steps, depicted by Step 100 in FIG. 1, the cleaning fluid of 9% potassium hydroxide concentration is held between 165-180° F. After cleaning the uncoated surface of the metal, the coated surface of the bumper should not show any blistering, delamination, or color fading. After cleaning, the bumper can be packaged and shipped, or a plated metal coating can be added to the uncoated surface.

The uncoated surface of the bumper can be plated according to methods well known in the art. This process is depicted by Step 110 in FIG. 1. Appropriate metals for plating include, but are not limited to, nickel and chrome. For a motor vehicle bumper, only the front side of the bumper needs to be treated, as the back side has the coating of the present invention as a corrosion barrier. Once plating is complete, the bumper can be packaged and shipped or installed on a motor vehicle.

In one embodiment, the metal article is formed into a three-dimensional article with opposing front and back sides. In another embodiment, the metal surface that is coated is one side of a metal sheet. More particularly, in one embodiment, the back side of the metal sheet is coated and the front side is electroplated with one or more layers of a metallic plating element.

More particularly, in one embodiment, the metal article is a bumper for a motor vehicle. FIG. 1 is a flowchart that illustrates a manufacturing process for making a metal motor vehicle bumper. First, a metal blank is selected, as shown in Step 10. The surface that will be the back of the metal bumper is cleaned, as shown in Step 30. Then, in Step 40, the surface is pretreated. A sealer is applied in Step 50, followed by a primer in Step 60. In Step 70, a top coat is applied. In one embodiment, the surface of the metal is ground before cleaning, as shown in Step 20. In another embodiment, the uncoated side of the metal is cleaned and polished to a desired surface finish before being pressed into a three dimensional shape. This is depicted in Step 80. In another embodiment, the metal is formed into a desirable shape. This is depicted in Step 90. In an additional embodiment, the metal can be electrochemically cleaned and electroplated with one or more metals, as shown in Steps 100-110.

It is possible, however, that one or more steps depicted in FIG. 1 may be repositioned, removed, or otherwise modified. It is envisioned that alternate methods of accomplishing the method of the present invention may be adopted without deviating from the invention as portrayed.

Described below are specific examples relating to the process for coating metal components according to the present invention. Also disclosed are several tests that were undertaken to evaluate the effectiveness of the coating of the present invention. The examples are provided so the invention may be more fully understood and are not meant to limit the scope of the invention in any way.

### EXAMPLES

### Example 1

### Application of Coating

This example is directed to a process for producing a metal motor vehicle bumper by selecting a flat metal blank, applying a coating to the back side surface of the metal blank, and then using a multi-step stamping process to form the flat metal blank into the desired shape.

For this example, a flat, cold rolled steel blank that was 23 inches wide, 102 inches long, and 0.063 inches thick was selected for coating. The selected flat, cold rolled steel blank was then placed on a coating line that was equipped with an abrasion station, a pretreatment station, a primer application station, a top coat application station, and a gas-fired cure oven. This coating line was designed to abrade, clean, pretreat, and prime the metal blank.

When the blank was placed on the coating line, it was first abraded using standard techniques known in the metal finishing art. After this step, the selected metal blank was cleaned with a water-borne alkaline cleaner at 150° F., which was applied by surface spraying using spray nozzles. The metal blank was then treated with a water-borne iron phosphate pretreatment at 150° F., which was applied by surface spraying using spray nozzles. The coating weight of the iron phosphate pretreatment applied to the metal blank was 20 mg/ft². The iron phosphate pretreatment was sealed with a water-borne non-chrome dry-in-place sealer, which was applied by roll coating the surface. The dry-in-place sealer was then dried using ambient air. The coating weight of the non-chrome sealer was 16 mg/ft².

After the sealer was applied, the metal blank was primed with a gray polyester/urethane chrome-free primer, which was applied using air assisted airless spray guns to achieve the desired wet film build. After the primer was applied, the coating line was stopped, and the metal blank was removed. After a one minute flash time at ambient temperature, it was placed in the gas-fired cure oven, which was set to 625° F., for about 2.5 minutes, which allowed the metal to reach the peak metal temperature of about 420° F. After about 2.5 minutes in the gas-fired cure oven, the blank was removed and allowed to cool. To ensure that the primer had been fully cured, the solvent resistance of the coating was checked using the standard MEK double rub test method, described in the coating industry as ASTM Test Method D5402-06. The number of double rubs for the material should be between 10 to 25, indicating that the primer has been fully cured. In this example, the MEK double rub was 14. The dry film build of the primer layer was 12.7 microns, which was measured using an elcometer.

After the metal blank had been allowed to cool to ambient temperature, it was loaded back onto the coating line at the top coat application station. Once loaded, the line was powered on, and the blank was passed under a curtain coater to apply the desired black PVC top coat and the desired wet film build. After a one minute flash time at ambient temperature, it was placed in the gas-fired cure oven, which was set to 625° F., for about 2.5 minutes, which allowed the metal to reach the peak metal temperature of 420° F. After 2.5 minutes in the gas-fired cure oven, the blank was removed and allowed to cool to ambient temperature. The dry film build of the PVC top coat was 89 microns, which was measured using an elcometer.

### Quality Control Testing

After the PVC top coat was applied, the coated metal blank was subjected to a series of tests to determine the quality of the coating. In this example, the primer/top coat coating had a gloss of 20 at 60° using a gloss meter. The coating system also demonstrated a pencil hardness of B. The blank exhibited no cracking when bent over a mandrel. It showed no cracking or delaminating from the metal substrate when subjected to deforming of the metal and coating with a ball and ring press. After four hours of submersion in boiling water, the deformed, coated blank showed no blistering or loss of adhesion.

### Bumper Formation

Once the coating had passed all quality control tests, the uncoated surface of the metal blank was polished using common metal polishing techniques that are well known in the art. After polishing, both the treated and the untreated sides of the metal blank were washed and treated with zinc phosphate. A die lube was then applied.

The blank was then placed in a stamping die, so that the coated side of the metal blank would be on the back side of the metal bumper in its final formed state and the polished side of the blank would be on the front side of the metal bumper in its final formed state. Typically, the first die defines the general shape of the bumper. The coating on the back side of the selected metal blank was subjected to about 500 to 1000 tons of force in the first forming step. After this first forming step, the coating on the back side showed no cracking, color change, or loss of adhesion to the metal.

The formed metal blank was then allowed to continue through the remaining press dies, where excess metal was trimmed away, notches and holes were punched in to the bumper for mounting brackets and fog lamps, and more definition was added to the shape of the metal bumper. After all of these subsequent forming steps, the coating on the back side of the bumper did not show any signs of tearing, fraying, cracking, or delaminating.

The final formed bumper was then cleaned using conventional methods that are well known in the art.

### Plating the Metal Bumper

The formed bumper was then mounted on a rack for electrochemical cleaning of the metal surface, followed by electrochemical plating of the bare metal surface with a layer of nickel and then a layer of chrome. The process for the electrochemical cleaning and metal plating of the bumper is a standard process that is well documented in the art.

### Inspection of Metal Bumper and Coating

The bumper was then inspected for any blistering, delaminating of the coating, or nickel and chrome deposits on the back side of the bumper. The primer/PVC coating did not show any signs of failure after the electrochemical cleaning and plating steps. There was no evidence of blistering, delaminating, peeling, or fracturing of the coating on the back side of the bumper. Additionally, there was no evidence of nickel or chrome plating that had penetrated the primer/PVC coating. There was very little nickel and chrome build-up on edges, holes, and punch outs on the bumper, which indicated that the nickel and chrome did not adhere to the PVC coating.

### Other Embodiments

The foregoing disclosure has been described in some detail by way of illustration and example, for purposes of clarity and understanding. The invention has been described with reference to various specific and preferred embodiments and techniques. However, it should be understood that many variations and modifications can be made while remaining within the spirit and scope of the invention. It will be obvious to one of skill in the art that changes and modifications can be practiced within the scope of the appended claims. Therefore, it is to be understood that the above description is intended to be illustrative and not restrictive.

The scope of the invention should, therefore, be determined not with reference to the above description, but should instead be determined with reference to the following appended claims, along with the full scope of equivalents to which such claims are entitled.

What is claimed is:

1. A method of coating the surface of a metal article, comprising the steps of:
a. cleaning the metal surface with one or more alkaline cleaners;
b. pretreating the metal surface with one or more phosphate-containing pretreating compounds;
c. applying one or more corrosion-resistant sealers to the metal surface;
d. applying one or more corrosion-resistant primers to the metal surface; and
e. applying one or more chemical- and corrosion-resistant top coats to the metal surface,
wherein the resulting metal surface is chemical-, corrosion-, and abrasion-resistant.

2. The method of claim 1, wherein the metal article is selected from the group consisting of pre-formed metal objects and metal blanks with a thickness between 0.001 and 5 inches.

3. The method of claim 1, wherein the metal article comprises a material selected from the group consisting of brushed or unbrushed hot rolled steel, brushed or unbrushed cold rolled steel, and brushed or unbrushed high strength steel.

4. The method of claim 3, wherein the metal article comprises a material selected from the group consisting of Drawing Steel, Deep Drawing Steel, Extra Deep Drawing Steel, and High Strength Low Alloy Steel.

5. The method of claim 1, further comprising the step of grinding the surface of the metal article to provide an abraded surface that is free of residue, oil, and grease.

6. The method of claim 1, wherein the surface of the metal article is cleaned by a process selected from the group consisting of cleaning in a vat and cleaning by surface spraying and scrubbing, and combinations thereof, using a cleaner selected from the group consisting of Betz Kleen 132®, 111 Low Foam Cleaner®, and mixtures thereof.

7. The method of claim 1, wherein the surface of the metal article is pretreated with a phosphate-containing pretreating compound selected from the group consisting of chromic phosphate, ferrous phosphate, ferric phosphate, zinc phosphate, and mixtures thereof.

8. The method of claim 7, wherein the surface of the metal article is pretreated with a material selected from the group consisting of Permatreat® 1510, Permatreat® 2105, Bonderite 902, Bonderite 2010, ChemCote 3010, Gardobond 51/2, Permatreat® 407, and mixtures thereof.

9. The method of claim 1, wherein the pretreating compound is applied by a process selected from the group consisting of spraying the metal, dipping the metal, brush coating the metal, roll coating the metal, and combinations thereof, to a coating weight of 10-100 mg/ft².

10. The method of claim 1, wherein the sealer is selected from the group consisting of chrome sealers selected from the group consisting of Betz Sealguard™ 750, Bonderite 1402W, Gardobond C 4571, and mixtures thereof, and non-chrome sealers, selected from the group consisting of Betz® DC2068, Bonderite 1455 SF, and mixtures thereof.

11. The method of claim 1, wherein the sealer is applied by a process selected from the group consisting of dipping the metal, roll coating the metal, spraying the metal, brush coating the metal, and combinations thereof, to a coating weight of 2-50 mg/ft².

12. The method of claim 1, wherein the primer is selected from the group consisting of water borne primers, solvent borne primers, liquid solvent borne high solids primers, powder primers, and mixtures thereof.

13. The method of claim 12, wherein the primer comprises a material selected from the group consisting of thermoplastic acrylic, polyester, polyvinyl, polyepoxy, polyurethane, polyamide, polyamine, acrylic carbamate resin systems, and mixtures thereof.

14. The method of claim 13, wherein the primer comprises curable resin with functional groups that are selected from the group consisting of hydroxyl, carboxylic acid, carbamate, anhydride, amine, epoxy, amide, carbonate, and mixtures thereof, wherein the functional groups of the primer are reacted with a crosslinking agent selected from the group consisting of isocyanates, blocked isocyanates, aminoplasts, melamines, epoxies, anhydrides, and mixtures thereof.

15. The method of claim 14, wherein the primer is a polyester resin system that contains hydroxyl groups that are crosslinked with blocked or unblocked isocyanates, or combinations thereof.

16. The method of claim 1, wherein the viscosity of a solvent borne primer is adjusted with a standard organic solvent selected from the group consisting of ketones, acetates, non polar aliphatic hydrocarbons, polar aliphatic hydrocarbons, polar aromatic solvents, non-polar aromatic solvents, alkyl polyethers, alkyl polyether acetates, and mixtures thereof, so that the viscosity of the primer is 20-40 seconds using a Zahn #2 viscosity cup.

17. The method of claim 1, wherein the primer contains one or more pigments selected from the group consisting of chrome and non-chrome pigments, wherein the pigment is selected from the group consisting of carbon black pigment, titanium dioxide, iron oxide, chrome yellow, moly orange, titanium yellow, nickel titanate yellow, chrome green, phathalo blue, phathalo green, perylene red, magenta red, and mixtures thereof.

18. The method of claim 1, wherein the primer is applied by a process selected from the group consisting of air atomized spray, air assisted airless spray, airless spray, HVLP spray, electrostatic rotary bell spray, electrostatic air atomized spray, electrostatic air assisted airless spray, electrostatic HVLP spray, direct roll coating, reverse roll coating, flow coating, dipping, curtain coating, and combinations thereof, to a dry film thickness of 2.5 microns to 50 microns.

19. The method of claim 1, wherein the primer is cured by a method selected from the group consisting of a heating means, short or medium long wave infrared light, and a combination of a heating means and infrared light.

20. The method of claim 19, wherein the primer is cured using a heating means with ovens that reach a peak metal temperature of 370-450° F., with an oven dwell time of 30-300 seconds.

21. The method of claim 1, wherein the top coat is selected from the group consisting of thermoplastic or thermoset water borne, solvent borne, solvent borne high solid, powder coating based on acrylic, polyester, epoxy, urethane, polyamide, polyamine, carbamate, polyvinylidine fluoride resin systems, and mixtures thereof.

22. The method of claim 21, wherein the top coat is selected from the group consisting of colloidal dispersions of polyvinyl chloride formulated with plasticizers selected from the group consisting of phthalate and non-phthalate based materials, and mixtures thereof.

23. The method of claim 22, wherein the top coat is a PVC plastisol coating.

24. The method of claim 1, wherein the top coat is selected from the group consisting of UV cured coatings and Electron Beam cured coatings.

25. The method of claim 1, wherein the viscosity of the solvent borne top coat is adjusted with water, nonpolar mineral spirits, or a standard organic solvent selected from the group consisting of ketones, acetates, non polar aliphatic hydrocarbons, polar aliphatic hydrocarbons, polar aromatic solvents, non-polar aromatic solvents, alkyl polyethers, alkyl polyether acetates, and mixtures thereof, so that the viscosity of the top coat is 15-40 seconds using a Zahn #4 viscosity cup.

26. The method of claim 1, wherein the top coat is pigmented with one or more colored pigments selected from the group consisting of inorganic pigments inorganic pigment selected from the group consisting of zinc white, zinc sulfide, carbon black, iron manganese black, spinel black, chromium oxide, chromium oxide hydrate green, cobalt green, ultramarine green, cobalt blue, ultramarine blue, manganese blue, ultramarine violet, cobalt violet, manganese violet, red iron oxide, molybdate red, ultramarine red, brown iron oxide, mixed brown iron oxide, yellow iron oxide, nickel titanium yellow, chromium titanium yellow, cadmium sulfide, cadmium zinc sulfide, chromium yellow, bismuth vanadate, and mixtures thereof, and organic pigments selected from the group consisting of manoazo pigments, diazo pigments, anthraquinone pigments, bexnzimidazole pigments, quinacridone pigments, quinophthalone pigments, diteopyrrolopyrrole pigments, dioxzine pigments, indanthrone pigments, isoindolien pigments, isoindolinone pigments, azomethine pigments, perinone pigments, perylene pigments, phthalocyanine pigments, aniline black, and mixtures thereof.

27. The method of claim 1, wherein the top coat is applied by a process selected from the group consisting of air atomized spray, air assisted airless spray, airless spray, HVLP spray, electrostatic rotary bell spray, electrostatic air atomized spray, electrostatic air assisted airless spray, electrostatic HVLP spray, direct roll coating, reverse roll coating, flow coating, dipping, curtain coating, and combinations thereof, to a dry film thickness of 2.5-400 microns.

28. The method of claim 1, wherein the top coat is cured by a method selected from the group consisting of a heating means, short or medium long wave infrared light, and a combination of a heating means and infrared light.

29. The method of claim 28, wherein the top coat is cured using a heating means with ovens that reach a peak metal temperature of 370-450° F., with an oven dwell time of 30-300 seconds.

30. The method of claim 1, wherein the metal article is one side of a metal sheet.

31. The method of claim 1, further comprising forming the metal surface into a three-dimensional article with opposing front and back sides.

32. The method of claim 1, wherein the front side of the metal sheet is polished.

33. The method of claim 32, wherein the back side of the metal sheet is coated and the front side is plated with one or more layers of a metallic plating element.

34. The method of claim 1, wherein the metal article is a bumper for a motor vehicle.

35. A method of coating the surface of a metal article, comprising the steps of
a. cleaning the metal surface with Betz Kleen 132® or 111 Low Foam Cleaner®;
b. pretreating the metal surface with one or more pretreating compounds selected from the group consisting of Permatreat® 1510, Permatreat® 2105, Bonderite 902, Bonderite 2010, ChemCote 3010, Gardobond 51/2, and Permatreat® 407;
c. applying Bonderite 1455 SF to the metal surface;
d. applying a polyester resin primer system that contains hydroxyl groups that are crosslinked with blocked or unblocked isocyanates; and
e. applying a PVC plastisol top coat coating,
wherein the resulting coated metal surface is chemical-, corrosion-, and abrasion-resistant.

36. The method of claim 35, further comprising the step of plating the front side of the metal sheet with one or more layers of a metallic plating element

37. A metal motor vehicle bumper, wherein the metal bumper characterized by a surface that is:
a. cleaned with Betz Kleen 132® or 111 Low Foam Cleaner®;
b. pretreated with one or more pretreating compounds selected from the group consisting of Permatreat® 1510, Permatreat® 2105, Bonderite 902, Bonderite 2010, ChemCote 3010, Gardobond 51/2, and Permatreat® 407;
c. sealed with Bonderite 1455 SF;
d. coated with a polyester resin primer system that contains hydroxyl groups that are crosslinked with blocked or unblocked isocyanates; and
e. coated with a PVC plastisol top coat;
wherein the resulting metal motor vehicle bumper has a chemical-, corrosion-, and abrasion-resistant coating.

38. The metal bumper of claim 37, wherein only the back side of the metal motor vehicle bumper is coated.

39. The metal object of claim 38, further comprising one or more layers of a metallic plating element on the front side of the metal motor vehicle bumper.
